(19) United States
(12) Patent Application Publication
(10) Pub. No.: US 2024/0060643 A1
(43) Pub. Date: Feb. 22, 2024

(54) REMOTE ASSISTED PLASMA IGNITION DEVICE & ITS APPLICATION

(71) Applicants: Wail AL-HARRASI, AlSeeb (OM); Hamed ALGHAFRI, Muscat (OM)

(72) Inventors: Wail AL-HARRASI, AlSeeb (OM); Hamed ALGHAFRI, Muscat (OM)

(21) Appl. No.: 18/028,419

(22) PCT Filed: Nov. 11, 2021
(86) PCT No.: PCT/OM2021/050009

§ 371 Date: Mar. 24, 2023

(30) Foreign Application Priority Data
Sep. 24, 2020 (OM) OM/P/2020/000374

(51) Int. Cl. F23Q 21/00; F23Q 7/16; H05H 1/52

(52) U.S. Cl. CPC F23Q 21/00; F23Q 7/16; H05H 1/52

(57) ABSTRACT

This application is to protect the design and application of a remote assisted plasma ignition device for the use but not restricted to the oil & gas industry. Which consists of four (4) main components: Power Supply Assembly (Solar PV+Battery), Remote Control system, Electronic control circuit, Plasma generator, High voltage cables and/or electrodes

The first 3 components (apart from PV solar cells) are housed in a sealed box according to the oil & gas standards. The plasma generator would be housed separately where high voltage cables stem from it to produce multiple plasma sparks. This novel device is placed immediately above the impacted site requiring no projectile system or specialized personnel to operate.

During the event of an uncontrolled gas leak, authorized person in charge such as drilling supervisor (DSV) would initiate the spark remotely following evacuation of the impacted site. Multiple plasma sparks would be initiated after following a specific remote ignition sequence. The scattered plasma spark around the impacted site would result in the ignition of the flammable fluids.

### TECHNICAL FIELD

High Voltage Plasma Discharge

### BACKGROUND ART

Oil and gas drilling and exploration are inherently risky operations caused by a mix of flammable hydrocarbon fluids and toxic gases. In the event of loss of control over drilling operations and loss of containments of these flammable toxic substances, the drilling team must ignite the impacted site to limit its spread to protect lives and the environment. Current techniques rely on flammable chemical projectiles that are ejected mechanically towards the top of the well and the burning chemicals continue to be ejected until the leaking gases ignite.

### SUMMARY OF INVENTION

This application is to protect the design and application of a remote assisted plasma ignition device for the use but not restricted to the oil & gas industry. Which consists of four (4) main components: Power Supply Assembly (Solar PV+Battery), Remote Control system, Electronic control circuit, Plasma generator, High voltage cables and/or electrode. The first 3 components (apart from PV solar cells) are housed in a sealed box according to the oil & gas standards. The plasma generator would be housed separately where high voltage cables stem from it to produce multiple plasma sparks. This novel device is placed immediately above the impacted site requiring no projectile system or specialized personnel to operate. During the event of an uncontrolled gas leak, authorized person in charge such as drilling supervisor (DSV) would initiate the spark remotely following evacuation of the impacted site. Multiple plasma sparks would be initiated after following a specific remote ignition sequence. The scattered plasma spark around the impacted site would result in the ignition of the flammable fluids.

### Technical Problem

The problem in the prior art lies in the use of harmful chemicals to the environment and because of the nature of the ejection of these substances in such a way as to ensure that they spread widely around the drilling area, large quantities of chemicals are spread in the air and the surface of the earth, which may harm the wildlife and habitat of the area. The second shortcoming is the inaccuracy of the ejection process, which necessitates the repetition of the process to ensure the ignition of the gases, which may allow the gases to spread in the surrounding area, especially since these projectiles need to be prepared before use.

The third shortcoming is that specialist personnel beside the drilling personnel must be available for ignition, increasing human presence in a hazardous zone and putting at risk.

### Solution to Problem

The new invention is based on the ignition of leaking gases using plasma rays, a purely physical process that contains no chemicals or moving mechanical parts that leads to an increased likelihood of fault or damage, hence, disruption of the ignition process when needed. These two obstacles can be overridden by plasma rays.

This mechanism is also environmentally friendly and does not harm wildlife because it is not dependent on any form of chemical use.

Leaked gases can be remotely & instantly ignited by drilling staff without the need for specialized staff, thereby reducing human presence in hazardous zones such as drilling sites.

### Advantageous Effects of Invention

Non-chemical based technology
Fast acting ignition
Enables multiple sparks in multiple directions around the incident site.
Easy operation and does not need specialist personnel
Remotely operated reducing health and safety risks.
Effective under extremely wet conditions.

### BRIEF DESCRIPTION OF DRAWINGS

FIG. 1 presents a block diagram of the full system where the a device to generate HV plasma arc is powered by either a solar panel (1) or mains electricity (2). The power is used to charge a battery (3) that feeds the control panel (4). The plasma generator (5) is connected to an electrode assembly (6) to produce an arc.

FIG. 2 illustrates cylindrical design of the electrode assembly where the HV plasma generator (1) is connected to a central electrode (2) and perforated cylindrical electrode (3). The assembly is secured to the rig via non-metallic parts (4).

FIG. 3 illustrates a second design of the HV electrode assembly where it provides a moving plasma along the electrode. It contains a HV plasma generator (1) which is connected to 2 electrodes (2) with an increasing gap from end to end. The assembly is covered by a perforated non-metallic cover (3).

FIG. 4 A schematic illustration of the RF transmitter (1) containing 3 buttons for PIN entry (2) and an abort button (3) and 3 LED indicators (4)

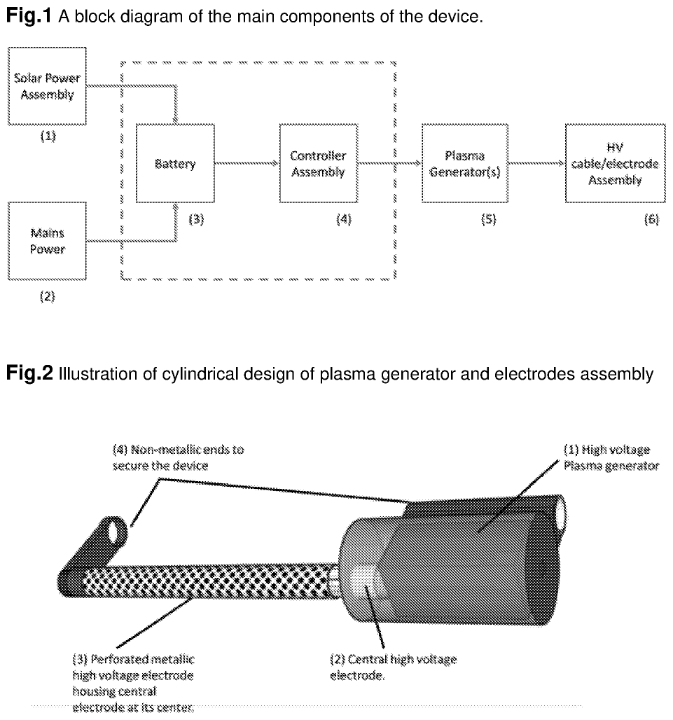

### DESCRIPTION OF EMBODIMENTS

The invention relates to a wireless plasma ignition. The device is constituted primarily of six main parts:
1. Power source (mains or PV cells)
2. Researchable Battery.
3. Control panel with RF receiver
4. RF transmitter
5. Plasma generator.
6. High voltage electrodes

The battery, electronic control circuit and RF receiver are housed in a sealed panel box. The plasma generator is housed separately where the high voltage cables/electrodes extend out generate multiple sparks. Unlike current techniques where the ignition and ejection device is away from the drilling site, the new device is placed on the structure of the drilling rig just meters above the well and the high voltage wires wrap around the perimeter of the drilling structure allowing for multiple sparks at different angles and locations.

In the event of an out-of-control gas leak, the personnel in charge of the drilling operations operates the device remotely with a wireless device according to a specific triggering sequence. Once the signal is received, the device generates a high voltage electric current that generates electrons with enormous energy that produce plasma rays in high voltage wires resulting in generation of multiple high frequency sparks in multiple locations of the impacted site.

The device merits itself to generating high voltage high frequency multiple plasma sparks or electrical sparks via capacitors to ignite impacted drilling sites in accordance with claim 1 of a device capable of generating plasma ignition sparks or electrical sparks via capacitors wirelessly with an electronic system that automatically detects the health of the device and consists of:

The power supply assembly which includes a rechargeable battery by solar PV cells or direct charging from the power outlets and is characterized according to claim no. 1 by automatically recharging itself and automatically stops churching according to the battery's power level and consisting of: solar PV cells, two charging mechanisms (solar and conventional), battery, and automatic control system.

An electronic control system characterized according to the claim no. 1 by regulating the battery charging process and regulating the mechanism of activation and deactivation of ignition and measuring the safety of the work of the device and its components and cover periodic reports and consists of electronic circuit, programmed electronic control system, and wireless receiver. The electronic panel will also contain an RF receiver that corresponds to an RF transmitter linked uniquely to it. The contorl panel output is sent to a single or multiple HV plasma generators.

HV plasma generator device generating multiple plasma sparks and characterized according to claim No. 1 being able to generate high-speed electron charges and generate plasma sparks consisting of high voltage adapter, plasma generators and special high voltage cables and/or electrodes. The plasma generation device connected to the electrodes in different configurations offering either a localized or moving arc. The configuration for a localized arc contains a metallic perforated shell which double as an electrode (3) in FIG. 2. the configuration of the moving arc has the electrodes (2) housed in a non-metallic perforated shell (3).

RF system used to trigger the plasma device comprises of RF receiver and transmitter units. The receiver unit will:

Only to respond to transmitter fobs programmed to it.
Be capable to learn two fobs.
Be able to learn new fobs.
Be able to learn new fobs to erase learnt fobs.
Be able to retain memory of learnt fobs when power is removed.
Be able to be programmed for the selected (PIN).

The design of the transmitter Fob will be as follows:
The (PIN) number will be controlled by the transmitter not the receiver.
The transmitter must also be paired to the receiver with a unique pairing procedure.
The transmitter will contain a button which will be used to put the transmitter into a mode to set the (PIN) code.
The Transmitter does not send any signals to the receiver until a correct (PIN) is entered.
The on signal will then be sent when the (PIN) is entered correctly.
A dedicated button on the transmitter to abort operation or to send an “off” command
Multiple buttons will be used to enter the (PIN)
The transmitter has 3 LEDs 1 LED for button confirmation, 1 LED for command transmission and 1 LED for battery health.
Transmitters to have belt clip fitted.
Transmitter to have IP kit fitted.

Operation or Rf receiver and transmitter:
To confirm any button press the Red LED will illuminate whilst the button is pressed when the correct pin is entered the transmitter Green LED will flash 2 times.
The buttons need to be pressed within 3 seconds of each press to continue the pin. If this is not fulfilled, the fob resets.
Once a receiver receives the correct PIN signal, it generates a latched digital output.
Overall design and application of the device and connecting individual parts to form the device to produce plasma ignition system.

### INDUSTRIAL APPLICABILITY

Applicable to the oil and gas industry to immediately burn toxic gases. It is also applicable in any industry requiring the same application.

1. The invention relates to a wireless plasma ignition device. The device is constituted primarily of five main parts: Power source assembly, a rechargeable battery, Control panel contains an electronic control system and RF receiver, RF transmitter, Plasma/spark generator, High voltage cables and electrodes.

2. A wireless plasma ignition device according to claim 1 where the power supply assembly which includes a rechargeable battery by solar PV cells or direct charging from the power outlets by automatically recharging itself and automatically stops charging according to the battery's power level and consisting of: solar PV cells, two charging mechanisms (solar and conventional), battery, and automatic control system.

3. A wireless plasma ignition device according to claim 1 where a device for generating multiple plasma sparks generate high-speed electron charges and generate plasma sparks consisting of: HV plasma generators and HV cables and/or electrodes.

4. A wireless plasma ignition device according to claim 1 where an electronic control system and wireless receiver operates by regulating the battery charging process and regulating the mechanism of activation and deactivation of ignition and measuring the safety of the work of the device and its components and cover periodic reports and consists of: electronic circuit, programmed electronic control system, and wireless receiver.

5. A wireless plasma ignition device according to claim 1 operated in the event of an out-of-control gas leak by the authorized personnel in charge of the drilling operations who operates the device remotely with a wireless device according to a specific triggering sequence or PIN code. Once the signal is received, the device generates a high voltage electric current that generates high energy electrons that produce plasma rays in high voltage electrodes resulting in generation of multiple high frequency sparks in multiple locations of the incident site.

6. A wireless plasma ignition device according to claim 1 offers a localized arc across the electrodes as shown in the design in FIG. 2 due to equal gap along the electrodes.

7. A wireless plasma ignition device according to claim 1 as shown in the design in FIG. 2 has a perforated metallic shell (3) doubles as an electrode.

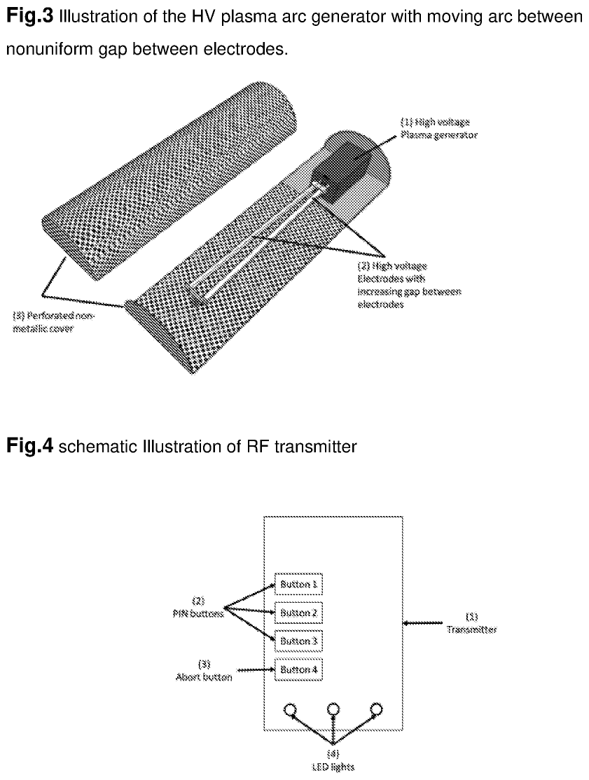

8. A wireless plasma ignition device according to claim 1 offers a moving arc across the electrodes as shown in the design in FIG. 3 due to variable gap size along the electrodes (2) allowing enhanced probability of contact between gas and arc.

9. A wireless plasma ignition device according to claim 1 as shown in FIG. 3 has a non-metallic perforated cover (3) that shields the electrode from moisture while allowing gases to penetrate.
